(19) United States
(12) Patent Application Publication
(10) Pub. No.: US 2014/0361043 A1
(43) Pub. Date: Dec. 11, 2014

(54) Apparatus For Maintaining The Temperature Of Syrup Through Use Of A Heat Sink

(71) Applicant: CORNELIUS, INC., ST. PAUL, MN (US)

(72) Inventors: Thaddeus M. Jablonski, Palatine, IL (US); Nikolay Popov, Naperville, IL (US)

(73) Assignee: CORNELIUS, INC., ST. PAUL, MN (US)

(21) Appl. No.: 14/223,577

(22) Filed: Mar. 24, 2014

Related U.S. Application Data
(60) Provisional application No. 61/831,517, filed on Jun. 5, 2013.

(51) Int. Cl. B67D 7/80

(52) U.S. Cl. CPC B67D 1/0857; B67D 1/0021
USPC 222/146.6

(57) ABSTRACT

An apparatus used in drop-in, under the counter beverage dispense systems for maintaining the temperature of a syrup by utilizing a heat sink. The apparatus consists of a delivery system that can produce a finished drink product at temperatures between 32 to 40 degrees (F.). The apparatus utilizes the conductive cooling of an ice bin through a heat sink to maintain the temperature of a diluent and syrup product at or near 32 degrees (F.).

This Application claims the benefit of the filing date under 35 U.S.C. §119(e) of U.S. Provisional Application No. 61/831,517, filed on Jun. 5, 2013, which is hereby incorporated by reference in its entirety.

### FIELD OF THE INVENTION

The present invention relates to a beverage dispense dispensing system more particularly to an apparatus for maintaining the temperature of a syrup by utilizing a cold-plate heat exchanger.

### BACKGROUND OF THE INVENTION

A typical drink dispense system includes an ice bin and a cold-plate heat exchanger. In the typical drink dispense system, a diluent (either still or carbonated water) and a drink syrup are transported through tubes through a cold-plate heat exchanger. The diluent and syrup are then transported through tubes to a drink dispense valve located a distance from the cold plate. The tubing located between the cold-plate and the dispense valve is protected from the ambient air by utilizing a minimal amount of insulation. The insulation is not sufficient to protect the temperature of the diluent and drink syrup from increasing over a period of time. Typically, the insulation is not sufficient to protect the temperature of the diluent and drink syrup from increasing over a period of time. The temperature of the diluent and drink syrup typically exits the cold plate at approximately the freezing point of ice. As the diluent and drink syrup rests in the tubing between the cold plate and the dispense valve, the temperature of the diluent and drink syrup will increase over time, especially if a drink is not dispensed for a lengthy period of time. Thus, the temperature of the drink dispensed from the valve is a relatively warm product.

The greater the amount of diluent and drink syrup exposed to the ambient air between the cold-plate and the valve(s), the warmer the drink will be. This situation is particularly true in the type of ice beverage system known as a “drop in” unit. This unit contains a cold-plate that resides above floor level and a valve(s) that is above counter top height. The length of the riser tubes between the cold-plate and valve(s) creates the undesirable situation where the tubing is exposed to the ambient air; which presents challenges when designing a system to meet the cold drink specification.

Therefore there exists a need to find a means to reduce the exposure to ambient air of the diluent and drink syrup dwelling in the riser tubes located above the counter in order to maintain the product in these tubes at a colder temperature. The unique construction and component layout of a “drop in” unit requires that the riser tubes pass parallel to the ice bin hopper for some distance on their path to the valve(s). There exists a need to use the material used for the walls of the ice bin, typically stainless steel (a good conductor), in connection with the “riser” tubing to exchange heat between ice bin wall and the riser tubes, thereby reducing the effective exposure to the ambient air temperature. The greater the surface area contact the greater the heat exchange. To affect this, a number of techniques may be used. A cradle made of a good heat conductor can be made to contact at least half the area of the tubing and also be brought in contact with a wide portion of the bin wall.

### SUMMARY OF THE INVENTION

The present invention consists of a mechanism by which a more effective path between the ice bin and product contained in riser tubes can be affected to produce a colder drink product and thus a higher quality drink.

It is a key objective of any beverage delivery system to deliver a high quality drink. This includes the ability to produce a finished drink that is between 32 to 40 degrees (F.). This requirement must be maintained even after the water and syrup products have been maintained in an ambient state after a prolonged period of non-use.

A further object of the invention is to utilize the conductive cooling of an ice bin to maintain the temperature of the diluent and syrup in the “riser” tubes through use of a heat sink in direct contact with the bin wall and hold them firmly in place with an external plate that draws the tubing tightly to the wall.

The primary objective of the present invention is to take advantage of the proximity of the ice bin to the “riser” tubes and utilize a heat sink in conjunction with the ice bin to maintain the product in the “riser” tubes at a cold temperature thus improving the drink quality.

### BRIEF DESCRIPTION OF DRAWINGS

FIG. 1—A perspective view of drop-in, under the counter-beverage dispense system.

FIG. 2—Illustration of the internal view of the ice bin and syrup delivery tubes

FIG. 3—A top view of one embodiment of the invention depicting the syrup and tubes and the heat sinker.

FIG. 4—A top view of a second embodiment of the invention depicting the syrup and tubes and the heat sinker.

FIG. 5—A top view of a third embodiment of the invention depicting the syrup and tubes and the heat sinker.

FIG. 6—A perspective view of an individual heat sink.

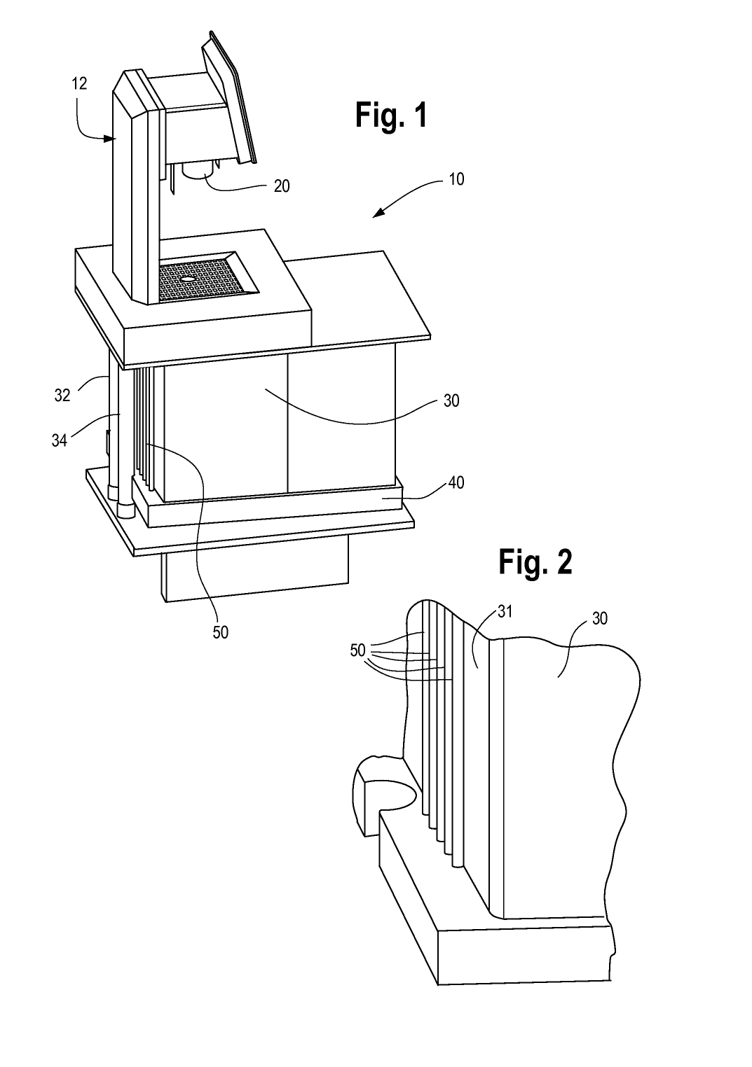

### DETAILED DESCRIPTION OF THE PREFERRED EMBODIMENTS

A typical “drop in” drink delivery system 10 includes a nozzle 20, ice bin 30, a still water delivery system 32 and carbonated water delivery system 34. The system 10 also includes a cold-plate heat exchanger 40 which rests at the bottom of the ice bin 30. Various syrups are passed through syrup tubes 50 which extend through the cold-plate heat exchanger 40 positioned along the lower portion of the ice bin 30. Syrup tubes 50 continue above the top portion of the drink delivery system 10 into an external platform 12 which typically resides above-the-counter of the drink delivery system 10.

In such a system, water (still 32 and carbonated 34) and syrups are passed through the cold plate heat exchanger 40, and then delivered to the nozzle 20 for dispensing. Product resides in the cold-plate heat exchanger 40 at approximately the freezing point of ice, 32 degrees (F.). Tubes 50 contain the syrup and the still water tube 32 and carbonated water tube 34 reside between the cold plate heat exchanger 40 and nozzle 20 is typically in a position within the system 10 that does not receive any cooling. The syrup tubes 50, the still water tube 32 and carbonated water tube 34 are typically only insulated from the ambient air, the cold-plate heat exchanger 40 only extends along the base of the ice bin 30. The temperature of syrups contained in the syrup tubes 50 will decay to room temperature over a period of time. In such instances, the temperature of the drink produced is a mixture of cold water from tubes 32 and 34 and warm syrup product delivered through tubes 50 decays over time. The greater the amount of water/syrup in the ambient volume between the cold-plate and the valve(s), the warmer the drink will be. This situation is particularly true in the type of ice beverage system known as a “drop in” system 10. The “drop in” system 10 contains a cold-plate heat exchanger 40 and a nozzle 20 that is above counter top height. The extended length of the syrup tubes 50 from the cold-plate heat exchanger 40 and nozzle 20 exposes the syrup to the ambient temperature of the room thus increasing the temperature of the syrup within tubes 50. The “drop in” system 10 described above is a good example of a system having a large ambient volume, which presents challenges when designing a system to meet the cold drink specification.

Therefore, there exists a need to reduce the exposure of tubes 50 to the ambient temperature so that the syrup product in the tubes 50 can be maintained at temperatures that approximate the temperature within the cold-plate heat exchanger 40 which is below the ambient temperature. The unique construction and component layout of a “drop in” system 10 requires that the tubes 50 pass parallel to the ice bin 30 for a measured vertical distance on the path to the nozzle 20. The materials used for the walls of the ice bin 30 may be stainless steel (a good conductor). The syrup tubes 50 may also be made of stainless steel (or plastic) thus there is the opportunity to bring the tubes 50 and the ice bin wall 31 of the ice bin 30 together in close contact to exchange heat between the ice bin 30, the ice bin wall 31, syrup tubes 50 and product, thereby reducing the effective ambient volume. The greater the surface area of contact between the cold-plate heat exchanger 40 and the syrup tubes 50 will maintain the temperature of the syrup within the tubes 50 to approximately 32 degrees (F.).

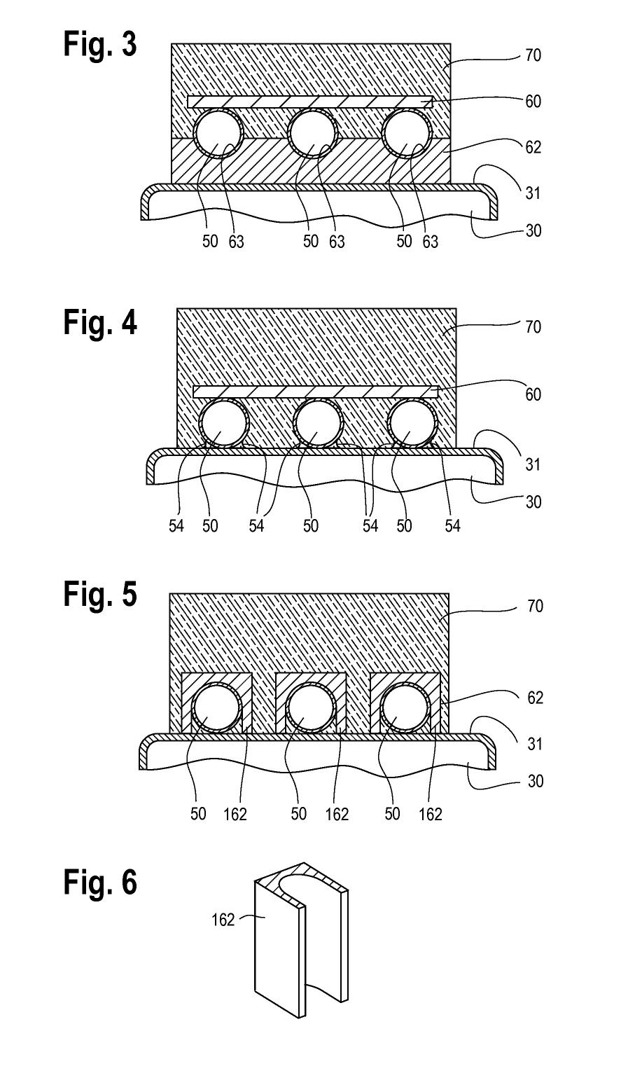

To effectuate maintaining the temperature of the syrup within the tubes 50, a number of techniques may be used. The first is shown in FIG. 3. A heat sink 62 is positioned along the ice bin wall 31 of the ice bin 30. The heat sink contains circular cut-out portions 63 which correspond to the radius of the tubes 50. The heat sink 62 is connected to the cold-plate heat exchanger 40, thus conducting the cold temperature to the tubes 50 in the same manner as the cold-plate heat exchanger 40. The heat sink 62 may extend along the entire wall 31 of ice bin 30 or it may also continue along the external platform 12. The system 10 also includes a plate 60 which is located opposite heat sink 62 which may also contact the cold-plate heat exchanger 40. The plate 60 operates to maintain the syrup within tubes 50 at a temperature approximated the temperature of the syrup as it exits the cold-plate heat exchanger 40. Insulation 70 may be added around the plate 60, tubes 50 and heat sink 62.

An alternative is depicted in FIG. 4. In this embodiment, the syrup tubes 50 are adhered to the wall 31 of the ice bin 30 by thermal paste 54. Thermal paste may be putty or mast. This embodiment also utilizes a plate 60 which may be connected to the cold-plate heat exchanger 40. The plate 60 helps maintain the temperature of the syrup within tubes 50 at a temperature approximating the temperature of the ice bin 30. Insulation 70 may be added around the plate 60 and tubes 50.

A final embodiment is depicted in FIGS. 5 and 6. In this embodiment, the tubes 50 are placed along wall 31 of said ice bin 30. Individual heat sinks 162 encompass tubes 50. The individual heat sinks 162 are connected to the cold-plate heat exchanger 40. Insulation 70 may be added around the individual heat sinks 162.

The primary goal here is to connect the cold-plate heat exchanger 40 to a heat sink 62, individual heat sinks 162 and/or a plate 60 to utilize the principles of conductivity and maintain the approximate temperature of the cold-plate heat exchanger 40 along the length of tubes 50.

While embodiments of the invention have been described in detail, various modifications and other embodiments thereof may be devised by one skilled in the art without departing from the spirit and scope of the invention, as defined in the appended claims.

What is claimed:

1. A beverage delivery apparatus comprising:
a nozzle;
a carbonated water delivery system in which carbonated water is delivered to said nozzle;
an ice bin having a top, bottom and side portions;
a cold-plate heat exchanger in proximate contact with the bottom portion of said ice bin;
a syrup tube extending through said cold-plate heat exchanger and along said side portion of said ice bin to said nozzle;
individual heat sink positioned along the length of said syrup tubes along said side portion of said ice bin and further contacting said cold-plate heat exchanger wherein the approximate temperature of said cold-plate heat exchanger is conducted through said individual heat sink.

2. The beverage delivery apparatus of claim 1, wherein said syrup tubes are adhered to said cold plate by thermal paste.

3. The beverage delivery apparatus of claim 1, wherein said syrup tubes are adhered to said side of said ice bin by thermal paste.

4. The beverage delivery apparatus of claim 1, wherein said heat sink includes a cut-out portion adapted to receive said syrup tube.

5. The beverage delivery apparatus of claim 1, further including a plurality of syrup tubes wherein each said syrup tube has a corresponding individual heat sink associated therewith.

6. The beverage delivery apparatus of claim 5, further including a plurality of syrup tubes wherein said syrup types are adhered to said cold plate by thermal paste.

7. The beverage delivery apparatus of claim 6, further including a plurality of syrup tubes wherein said syrup tubes are adhered to said side of said ice bin by thermal paste.

8. The beverage delivery apparatus of claim 7, further including a plurality of syrup tubes wherein said heat sink includes a cut-out portion adapted to receive said syrup tube.

9. The beverage delivery apparatus of claim 1, further including a plurality of syrup tubes.

10. The beverage delivery apparatus of claim 9, further including a plurality of syrup tubes wherein said individual heat sink is a unitary structure.
